(19) United States
(12) Patent Application Publication
(10) Pub. No.: US 2012/0267145 A1
(43) Pub. Date: Oct. 25, 2012

(54) Flat cable and cable harness using same

(75) Inventors: Detian Huang, Hitachi (JP); Noriyuki Imai, Hitachi (JP); Takanobu Watanabe, Hitachi (JP); Hiroshi Komuro, Hitachi (JP)

(73) Assignee: Hitachi Cable Fine-Tech, Ltd., Ibaraki (JP)

(21) Appl. No.: 13/137,148

(22) Filed: Jul. 22, 2011

(30) Foreign Application Priority Data
Apr. 21, 2011 (JP) 2011-095129

(51) Int. Cl. H01B 7/08

(52) U.S. Cl. 174/117 F

(57) ABSTRACT

A flat cable includes a plurality of wires in parallel alignment, and a linear member disposed across the parallel alignment and woven between the plurality of wires. The linear member includes a fibrous member containing poly(trimethylene terephthalate) and a metal layer on a periphery of the fibrous member. A cable harness includes the flat cable, and a connecting terminal connected to an end of the flat cable.

The present application is based on Japanese Patent Application No.2011-095129 filed on Apr. 21, 2011, the entire contents of which are incorporated herein by reference.

### BACKGROUND OF THE INVENTION

1. Field of the Invention

This invention relates to a flat cable and, in particular, to a flat cable suitable for being wired in electronic devices such as a notebook computer, a liquid-crystal television and a printer. This invention also relates to a cable harness using the flat cable.

2. Description of the Related Art

Conventionally, in electronic devices such as a notebook computer, a liquid-crystal television or a printer, a flexible printed circuit (FPC) that is relatively flexible and capable of being arranged inside a thin flat electronic device is often used as a signal transmission wiring member that is wired at a connection part etc. between a main body for operating the electronic device and a display such as a liquid-crystal display.

Also, a flat cable with a shield layer is used as a wiring member in place of the FPC for preventing an electromagnetic interference (EMI) caused by unnecessary radiation. The flat cable is constructed such that plural thin wires (e.g., coaxial cables) are flatly arranged, the flatly-arranged wires is wholly wrapped with a conductive cloth (i.e., a cloth with metal plating applied to a surface thereof) having an adhesive layer at one surface thereof and the shield layer is formed by joining edges of the conductive cloth,

The related art to the invention may be JP-A-2008-235024 and JP-A-2001-101934.

### SUMMARY OF THE INVENTION

When a wiring member composed of a flat cable is wired in an electronic device such as notebook computer, a liquid-crystal television and a printer, the flat cable is often wired in a wiring space between other members arranged in the electronic device so as not to overlap therewith. On the other hand, recently, electronic devices are desired to be downsized and the wiring space for the wiring member tends to be restricted. Therefore, as a wiring member to be wired in such a restricted wiring space, a flat cable 20 is strongly desired whose wiring direction can be changed by being meandered in the width direction (i.e., in the parallel alignment direction of wires) so as to avoid other members 21 and 22 as shown in FIG. 2.

In the conventional flat cable using the conductive cloth, a portion to which the conductive cloth is adhered is hard and is thus difficult to bent. When it is forcibly bent, the wire enclosed therein may be broken and the joint portion of the conductive cloth may be separated. This problem may be serious especially when the flat cable is wired being bent 180° at a predetermined position.

Also, when wired in a region requiring a slide (i.e., U-shaped slide) while the flat cable is bent 180° at a predetermined position such as a position between a control section of a printer and a printer head etc., the conventional flat cable is low in U-shaped slide property (i.e., the life of U-shaped slide is short). Thus, it is difficult for the conventional flat cable to have the U-shaped slide property as well as the EMI property.

Accordingly, it is an object of the invention to provide a flat cable that can offer an EMI countermeasure, have a high U-shaped slide property, be easily bent and be easily wired even in a non-linear wiring space, as well as a cable harness using the flat cable.

(1) According to one embodiment of the invention, a flat cable comprises:

a plurality of wires in parallel alignment; and

a linear member disposed in a direction of the parallel alignment and woven between the plurality of wires,

wherein the linear member comprises a fibrous member comprising poly(trimethylene terephthalate) and a metal layer on a periphery of the fibrous member.

In the above embodiment (1) of the invention, the following modifications and changes can be made.

(i) The metal layer comprises a metal wire helically wound around the fibrous member, and the metal wire comprises a cross-sectional shape except a circular shape.

(ii) The metal layer comprises a copper plating or a silver plating.

(iii) The metal wire is formed by rolling, and a breaking elongation and a tensile strength after the rolling are more than those before the rolling.

(iv) Before the rolling, the metal wire has a tensile strength of not less than 300 MPa and a breaking elongation of not less than 0.50%.

(v) The metal wire has a percentage of a difference between the tensile strength (σ₁) after the rolling and the tensile strength (σ₀) before the rolling to the tensile strength (σ₀) before the rolling: 0%<100×(σ₁−σ₀)/σ₀≦50%.

(vi) The metal wire has a percentage of a difference between the breaking elongation (δ₁) after the rolling and the breaking elongation (δ₀) before the rolling to the breaking elongation (δ₀) before the rolling: 10%≦100×(δ₁−δ₀)/δ₀≦60%.

(vii) The plurality of wires each comprise an inner conductor and an insulation layer on a periphery of the inner conductor.

(viii) The plurality of wires each further comprise an outer conductor comprising a plurality of linear materials on a periphery of the insulation layer, and a jacket on a periphery of the outer conductor.

(2) According to another embodiment of the invention, a cable harness comprises:

the flat cable according to the embodiment (1); and

a connecting terminal connected to an end of the flat cable.

### Effects of the Invention

According to one embodiment of the invention, a flat cable can be provided that can offer the EMI countermeasure, have high U-shaped slide properties, be easily bent and be easily wired even in a non-linear wiring space, as well as a cable harness using the flat cable.

### BRIEF DESCRIPTION OF THE DRAWINGS

Next, the present invention will be explained in more detail in conjunction with appended drawings, wherein:

FIG. 1 is a plan view showing a cable harness using a flat cable in an embodiment of the present invention; and

FIG. 2 is an explanatory diagram illustrating a method of wiring a flat cable.

### DETAILED DESCRIPTION OF THE PREFERRED EMBODIMENTS

A preferred embodiments of the invention will be described below in conjunction with the appended drawings.

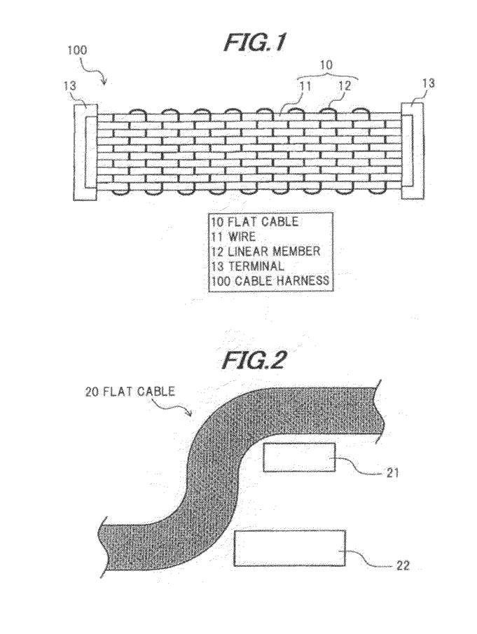

FIG. 1 is a plan view showing a cable harness 100 using a flat cable 10 in the embodiment.

As shown in FIG. 1, a flat cable 10 in the embodiment is provided with plural wires 11 arranged in parallel and a linear member 12. The linear member 12 is arranged along a parallel direction of the wires 11 (a direction substantially orthogonal to a longitudinal direction of the wire 11) so as to be woven between the plural wires 11 and has a metal layer provided around a fibrous member formed of poly(trimethylene terephthalate).

The flat cable 10 is manufactured by a manufacturing method including a step of arranging the plural wires 11 in parallel, a step of weaving the linear member 12 between the plural wires 11 along a parallel direction thereof and a step of heating the linear member 12.

The step of heating the linear member 12 is to heat at a temperature of, e.g., not less than 100° C. and not more than 120° C. At this time, it is desirable that heat treatment for heating the linear member 12 be performed at a temperature of not less than 100° C. and not more than 120° C. in the state that a below-described fibrous member contains moisture.

A heat treatment method for obtaining the flat cable 10 includes, e.g., a method in which a flat cable body formed by weaving the linear member 12 between the wires 11 is treated to impregnate water into a fibrous member and a heating roll heated to not less than 100° C. and not more than 120° C. is subsequently moved in a longitudinal direction of the flat cable body along a surface of the linear member 12 to heat the linear member 12, or a method in which a flat cable body is placed in a heat treatment equipment such as constant-temperature oven and the linear member 12 is subsequently heated at a temperature of not less than 100° C. and not more than 120° C. while impregnating water into a fibrous member by spraying water vapor (steam) thereon. Alternatively, in the method described above, heating may be carried out while impregnating water into a fibrous member using a heating roll having a function of spraying water vapor. The fibrous member is contracted by the heat treatment and each wire 11 is held in a neatly arrayed state. An indentation caused by contraction of the fibrous member which constitutes the linear member 12 is less likely to be generated on the surface of each wire 11. The width of the flat cable body is contracted from, e.g., about 15 mm to about 11 mm by the heat treatment, and the flat cable 10 is thus obtained.

### Wire

The wire 11 is an insulated wire which has at least an inner conductor formed by twisting plural copper wires together and an insulator provided on the outer periphery of the inner conductor.

The insulator is formed of a fluorine resin such as tetrafluoroethylene-perfluoroalkyl vinyl ether copolymer (PFA), tetrafluoroethylene-hexafluoropropylene copolymer (FEP) or ethylene-tetrafluoroethylene copolymer (ETFE), or polyethylene terephthalate (PET).

Alternatively, the wire 11 may be a coaxial cable having an outer conductor formed by laterally winding plural metal conductors around the outer periphery of the insulator in a spiral manner and a jacket provided around the outer periphery of the outer conductor.

Then, the outer conductor is a conductor (single or twisted wire) formed of a metal wire such as annealed copper wire (including a wire of which surface is plate-processed).

In light of the serpentine wiring, it is preferable that the jacket as the outermost layer be a layer having an elongation percentage of not less than 20% and not more than 150% and a tensile strength of not less than 150 MPa.

By using the outermost layer having an elongation percentage of not less than 20% and not more than 150% and a tensile strength of not less than 150 MPa which is a layer harder than the conventional art, when a flat cable composed of such a wire is partially deformed to move parallel in a width direction, it is possible to effectively apply a force repelling in a direction opposite to a parallel movement direction (repulsive force) to a portion which is deformed (a deformed portion) without impeding parallel movement of the flat cable.

When the elongation percentage of the jacket is less than 20%, flexibility after being formed into a flat cable is greatly impaired, which makes difficult to meander by parallel moving a portion of the flat cable in a width direction. Meanwhile, when the elongation percentage of the jacket is more than 150%, a repulsive force of the deformed portion of the flat cable in a direction opposite to a parallel movement direction cannot be effectively applied to the deformed portion when a portion of the flat cable is moved parallel to meander. A material which satisfies these characteristics includes, e.g., PET.

The outermost layer is a tape layer formed of a plastic tape, and the tape layer has a first tape layer formed by helically winding (e.g., lap winding) a plastic tape and a second tape layer formed by helically winding (e.g., lap winding) a plastic tape on the first tape layer in a winding direction different from that of the first tape layer.

When the outermost layer is formed of the tape layer, the plastic tape is preferably a thin plastic tape (e.g., 2 to 3 mm in width and not more than 5 μm in thickness) which is formed by drawing and has an elongation percentage of not less than 30% and not more than 140%. This is because, when the elongation percentage is less than 30% or more than 140%, the outermost layer of the wire 11 may not satisfy the range of the elongation percentage and the tensile strength described above due to the heat during the step of heating the fibrous member.

In addition, the first tape layer is preferably formed of a shielding tape which is formed by depositing metal (e.g., depositing copper to be a thickness of 0.1 to 0.3 μm) on an inner side (outer conductor side) of the thin plastic tape, and the second tape layer is preferably formed of an adhesive tape composed of the thin plastic tape and an adhesive layer formed on an inner side (first tape layer side) thereof. Alternatively, a shielding tape or adhesive tape can be used alone when the tape layer is formed as a single layer. In addition, both the first and second tape layers may be formed of an adhesive tape.

Alternatively, the outermost layer may be a layer formed by extrusion-coating, etc., with a resin such as PET, ETFE, PFA or FEP besides the tape layer described above as long as the layer has the elongation percentage and tensile strength described above.

Considering that the wire 11 is wired in very small space inside a notebook computer, a liquid crystal television or a printer, etc., an outer diameter of the wire 11 is preferably not more than 0.35 mm.

### Linear Member

The linear member 12 is woven between the wires 11 from one end to another in a longitudinal direction of the flat cable 10 (from left to right side in the drawing) while reciprocating from one side to another in a width direction (from upper to lower side in the drawing) in a zigzag manner so as to longitudinally fix the plural wires 11 in a flat manner.

At this time, the linear member 12 should be woven over and under each unit of two or more wires 11 at the widthwise middle portion of the flat cable 10 (parallel direction of the wire 11) and should be woven over and under each unit of one wire 11 at widthwise edge portions of the flat cable 10. It should be noted that the widthwise middle portion of the flat cable 10 is not limited to a portion on a center axis of the flat cable 10 but includes the vicinity thereof. In addition, the widthwise edge portion of the flat cable 10 is not limited to the outermost position of the flat cable 10 in the width direction but includes the vicinity thereof.

Such a configuration reduces frequency that the linear member 12 is woven as compared to the case where the linear member 12 is woven over and under each unit of one wire 11, and it is possible to reduce generation of indentation on the surface of the wire 11 caused by weaving the linear member 12 and to decrease the width of the flat cable 10.

Although the linear member 12 is woven throughout the whole length of the flat cable 10, the linear member 12 at both lengthwise ends of the flat cable 10 is removed in order to facilitate attachment of a connecting terminal 13 used for connecting to a device such as a connector.

The ratio of the woven linear member 12 should be constant over the whole length of the flat cable 10 or should be less at the both ends than at the lengthwise middle portion of the flat cable 10. By decreasing the ratio of the woven linear member 12 at the both ends than at the lengthwise middle portion of the flat cable 10, the shape of the flat cable 10 is kept flat and removal work of the linear member 12 is facilitated when the connecting terminal 13 is attached to an end of the flat cable 10 to form a cable harness.

The ratio of the woven linear member 12 is represented by an equation “(d×N)/L” (where d is an outer diameter of the linear member) which is obtained based on the number (N) of the linear members 12 woven into the flat cable 10 (the wires 11) within a predetermined longitudinal length thereof (L mm), and the linear member 12 is preferably woven at a ratio of not less than 20 and not more than 30 per 10 mm of a longitudinal length of the wire 11. This makes the wire 11 not exposed from the weave texture of the linear member 12 and less likely to slip when the flat cable 10 is bent or meandered, and thus, when a portion of the flat cable 10 is deformed to move parallel in a width direction, it is possible to efficiently obtain a repulsive force generated in a deformed portion of the flat cable 10.

### Fibrous Member

The fibrous member constituting the linear member 12 is preferably formed of one or plural long fiber yarns attached side-by-side each of which is formed by bundling single or plural fibers. For example, two fiber yarns of 70 to 80 deniers each composed of thirty to forty monofilaments are attached side-by-side to form the fibrous member. Attaching side-by-side allows stress applied to the wire 11 to be reduced without excessively tightening the wires 11 when the linear member 12 is arranged so as to be woven between the wires 11.

It is preferable to use a fibrous member having an initial modulus of not less than 20 cN/dtex and not more than 30 cN/dtex and a recovery percentage of elongation of not less than 80% and not more than 95%.

It is possible to weave the linear member 12 without loading on the wire 11 by using a fibrous member having an initial modulus of not less than 20 cN/dtex and not more than 30 cN/dtex as described above. Following is a reason why a fiber having an initial modulus of not less than 20 cN/dtex and not more than 30 cN/dtex is used for the fibrous member constituting the linear member 12.

When a fiber having an initial modulus of less than 20 cN/dtex is used for the fibrous member, a force of tightening the wires 11 at the time of weaving the linear member 12 is weak, and it is not possible to manufacture a well-shaped flat cable 10. This raises the need of further providing a step of well shaping the linear member 12 after weaving the linear member 12, which leads to an increase in the manufacturing cost.

Meanwhile, when a fiber having an initial modulus of more than 30 cN/dtex is used for the fibrous member, a force of tightening the wires 11 at the time of weaving the linear member 12 is strong and the wire 11 is deformed in a wave-like manner when the linear member 12 is woven, leading to a decrease in workability such that work to connect a conductor to an electrode of a connector to be connected thereto is cumbersome, or leading to a decrease in transmission characteristics due to variation in characteristic impedance of the wire.

For the reason described above, a fiber having an initial modulus of not less than 20 cN/dtex and not more than 30 cN/dtex should be used for the fibrous member.

In addition, the recovery percentage of elongation of the fibrous member is not less than 80% and not more than 95% because, when the recovery percentage of elongation is less than 80%, stretch properties of the linear member 12 at the time of bending and sliding the flat cable 10 are insufficient, resulting in that the wire 11 is likely to be broken due to the slide, and when the recovery percentage of elongation is more than 95%, a contracting force of the linear member 12 at the time of bending and sliding the flat cable 10 is weak and the surface of the wire 11 is likely to be exposed from a gap between the woven linear member 12 at the time of sliding, which may result in that the exposed wire 11 is broken.

The recovery percentage of elongation was measured by a measuring method in accordance with “JIS L 1096” of JIS (Japanese Industrial Standard). That is, a test piece of the woven fibrous member with a width of 5 cm and a length of 30 cm is fixed at an upper portion of one end thereof by a clip, an initial load is applied to another end and two marks are made to indicate 20 cm, then, a load of 1.5 kg is applied in place of the initial load and a length L1 between the marks is measured after one hour, a length L2 between the marks which are made when applying the initial load is measured one hour after removing the load, and the recovery percentage of elongation is derived by the following formula 1.

Recovery percentage of elongation=(L1−L2)/(L1−20)×100 (Formula 1)

Since it is possible to impart stretch properties in a width direction of the flat cable 10 by using such a fibrous member for the linear member 12, stress applied by meandering the flat cable 10 to wire in very small wiring space or by bending and sliding the flat cable 10 in very small wiring space can be effectively released in the width direction of the flat cable 10. This results in allowing the wire 11 to move in the width direction of the flat cable 10. Therefore, the stress applied to the wire 11 is reduced even when being meandered to wire or being bent or slid in very small wiring space and it is thus possible to prevent breaking, etc., of the wire 11.

In addition, since it is possible to impart stretch properties in the width direction of the flat cable 10, it is possible to wire in a shape which matches the wiring space in a longitudinal direction of the flat cable 10.

For such a fibrous member, poly(trimethylene terephthalate) (PTT) fiber formed of a polycondensate of 1,3-propanediol and terephthalic acid (e.g., SOLOTEX (registered trademark) manufactured by SOLOTEX Corporation or T400 manufactured by Toray Industries, Inc., etc.) can be used.

At the time of weaving, the fibrous member is generally woven in a state of being fully elongated, which decreases flexibility of a flat cable after weaving. In addition, firmly tightening wires may cause the breaking when being bent.

On the other hand, since the fibrous member formed of PTT is further elongated about 10 to 50% by heating even after weaving, flexibility of the flat cable does not decrease and the wire 11 is not firmly tightened. Therefore, when the flat cable 10 is slid in a parallel direction, the fibrous member is elongated in accordance with the movement of the wire 11 in the parallel direction and the position thereof is changed.

In addition, it is possible to reduce the stress applied to the wire 11 at the time of sliding the flat cable 10 by using the fibrous member in which plural fiber yarns formed by bundling plural PTT fibers are attached side-by-side, and as a result, it is possible to improve resistance against bending or meandering, etc.

### Metal Layer

A metal wire obtained by rolling a copper or copper alloy wire is helically would around the fibrous member or copper or silver plating is applied on the fibrous member, thereby forming metal layer.

When the metal layer is formed of a metal wire, it is preferable that the metal wire after the rolling process have a cross-sectional shape other than a circle, such as a long oval shape or a substantially quadrangular (substantially rectangular) shape with no pointed corners, etc. For example, a copper or copper alloy wire having an outer diameter of 0.03 mm is rolled to shape into a metal wire of about 0.11 mm in width and about 0.006 mm in thickness. Since the metal layer is provided by helically winding such a metal wire having a cross-sectional shape other than a circle, bending strength of the metal wire can be reduced and the flat cable 10 itself does not become hard even though the linear member 12 having a metal layer is woven into the flat cable 10, hence, it is possible to wire in very small wiring space by easily meandering or bending and to provide EMI characteristics.

It is preferable that the metal wire have an outer diameter of not less than 0.03 mm and not more than 0.1 mm before the rolling process and have a thickness of not less than 0.006 mm and not more than 0.025 mm and a width of not less than 0.10 mm and not more than 0.40 mm after the rolling process.

Meanwhile, in the metal wire, the tensile strength after the rolling process of the copper or copper alloy wire (σ₁) is preferably greater than the tensile strength before rolling process of the copper or copper alloy wire (σ₁)). Specifically, a ratio of a difference between the tensile strength after the rolling process of the copper or copper alloy wire (σ₁) and the tensile strength before rolling process of the copper or copper alloy wire (σ₀) to the tensile strength before rolling process of the copper or copper alloy wire (σ₀) (an increasing rate of the tensile strength due to the process=100×(σ₁−σ₀)/σ₀) should be greater than 0% and not more than 50% (0%<100×(σ₁−σ₀)/σ₀≦50%). Then, the tensile strength before rolling process of the copper or copper alloy wire (σ₀) should be not less than 300 MPa.

In addition, in the metal wire, the breaking elongation after the rolling process of the copper or copper alloy wire (δ₁) is preferably greater than the breaking elongation before rolling process of the copper or copper alloy wire (δ₀). Specifically, a ratio of the a difference between the breaking elongation after the rolling process of the copper or copper alloy wire (δ₁) and the breaking elongation before rolling process of the copper or copper alloy wire (δ₀) to the breaking elongation before rolling process of the copper or copper alloy wire (δ₀) (an increasing rate of the breaking elongation due to the process=100×(δ₁−δ₀)/δ₀) should be not less than 10% and not more than 60% (10%≦100×(δ₁−δ₀)/δ≦60%), and more preferably, not less than 20% and not more than 50%. Then, the breaking elongation before rolling process of the copper or copper alloy wire (δ₀) should be not less than 0.50%. The tensile strength (σ) and the breaking elongation (δ) of the copper or copper alloy wire described above are obtained by test methods in accordance with JIS (JIS Z 2241 “Method of tensile test for metallic materials”).

The use of the metal wire described above allows the flat cable 10 to be wired by meandering or bending when the flat cable 10 is wired in small non-linear wiring space. In addition, terminal processing such as attaching a connector, etc., to a terminal of coaxial cable to form a cable harness is facilitated and it is possible to easily perform end processing of the metal layer without requiring cumbersome work and time.

The metal wire is helically wound around the fibrous member at a predetermined pitch so that surfaces located in a width direction join each other. However, a method of winding the metal wire is not limited thereto. The winding pitch of the metal wire is, e.g., not less than 1.3 times and not more than 2.0 times the width of the metal wire. This is effective to meander or bend a flat cable to wire in very small non-linear wiring space.

When the flat cable 10 is deformed and wired in a meander shape, the configuration described above enables a desired repulsive force to be effectively generated at the deformed portion of the flat cable 10, and it is possible to impart a force which adequately suppresses the movement of the linear member 12 in the meandering direction.

In other words, when the flat cable 10 is made into a meander shape, a moving force of the linear member 12 in the meander direction is balanced with the force of suppressing the movement. As a result, the flat cable 10 itself does not become hard, which allows a wiring direction of the wiring member to be changed by meandering so as to avoid other members and a meander shape to be maintained even when the flat cable 10 is wired in non-linear wiring space while taking a countermeasure against EMI.

Furthermore, since the linear member 12 is woven between the plural wires 11, it is possible to impart stretch properties in a width direction of the flat cable 10, and the stress applied to the wire 11 can be effectively released even when being wired by meandering or being bent or slid in very small wiring space. As a result, the stress applied to the wire 11 is reduced and it is thus possible prevent breaking, etc., of the wire 11 and to impart high U-shaped slide properties to the flat cable 10.

In addition, by connecting the connecting terminals 13 to the end of the flat cable 10, it is possible to obtain the cable harness 100 shown in FIG. 1 which allows easy wiring in non-linear wiring space by meandering without being bent.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A flat cable, comprising:
a plurality of wires in parallel alignment; and
a linear member disposed in a direction of the parallel alignment and woven between the plurality of wires,
wherein the linear member comprises a fibrous member comprising poly(trimethylene terephthalate) and a metal layer on a periphery of the fibrous member.

2. The flat cable according to claim 1, wherein the metal layer comprises a metal wire helically wound around the fibrous member, and the metal wire comprises a cross-sectional shape except a circular shape.

3. The flat cable according to claim 1, wherein the metal layer comprises a copper plating or a silver plating.

4. The flat cable according to claim 2, wherein the metal wire is formed by rolling, and a breaking elongation and a tensile strength after the rolling are more than those before the rolling.

5. The flat cable according to claim 4, wherein, before the rolling, the metal wire has a tensile strength of not less than 300 MPa and a breaking elongation of not less than 0.50%.

6. The flat cable according to claim 4, wherein the metal wire has a percentage of a difference between the tensile strength (σ₁) after the rolling and the tensile strength (σ₀) before the rolling to the tensile strength (σ₀) before the rolling: 0%<100×(σ₁−σ₀)/σ₀≦50%.

7. The flat cable according to claim 4, wherein the metal wire has a percentage of a difference between the breaking elongation (δ₁) after the rolling and the breaking elongation (δ₀) before the rolling to the breaking elongation (δ₀) before the rolling: 10%≦100×(δ₁−δ₀)/δ₀≦60%.

8. The flat cable according to claim 1, wherein the wire comprises an inner conductor and an insulation layer on a periphery of the inner conductor.

9. The flat cable according to claim 8, wherein the wire further comprises an outer conductor comprising a plurality of linear materials on a periphery of the insulation layer, and a jacket on a periphery of the outer conductor.

10. A cable harness, comprising:
the flat cable according to claim 1; and
a connecting terminal connected to an end of the flat cable.
